(19) United States
(12) Patent Application Publication
(10) Pub. No.: US 2008/0033646 A1
(43) Pub. Date: Feb. 7, 2008

(54) Systems and Methods of Automated Retrieval of Location Information from a User Device for use with Server Systems

(76) Inventors: Edward J. Morgan, Needham, MA (US); Nicolas Brachet, Chestnut Hill, MA (US); Farshid Alizadeh-Shabdiz, Wayland, MA (US); Ryan Sarver, Boston, MA (US)

Correspondence Address: WILMERHALE/BOSTON, 60 STATE STREET, BOSTON, MA, 02109, US

(21) Appl. No.: 11/833,501

(22) Filed: Aug. 3, 2007

Related U.S. Application Data
(60) Provisional application No. 60/821,479, filed on Aug. 4, 2006.

(51) Int. Cl. G01C 21/00; G06F 17/30

(52) U.S. Cl. 701/213; 701/207

(57) ABSTRACT

Systems and methods of automated retrieval of location information from a user device for use with server systems are provided. A method of a server retrieving information indicative of a geographic position of a client device for use in selecting and send information based on the geographic position includes providing a server having location independent content and location dependent content. The client device sends a request to the server. In response to the request, the server sends a message to the mobile client device requesting information indicative of the geographic position of the client device. In response, the client device automatically sends information indicative of the geographic position of the client device to the server. In response to receiving the information indicative of the geographic position of the client device, the server selects location dependent content that corresponds to the client geographic position and sends it to the client device.

### CROSS-REFERENCE TO RELATED APPLICATIONS

This application claims the benefit under 35 U.S.C. §119(e) to the following U.S. Provisional Patent Application, the contents of which is incorporated by reference herein:
U.S. Provisional Patent Application No. 60/821,479, entitled WLAN Positioning System User Location Pulling Mode for Use in Client-Server Systems, filed on Aug. 4, 2006.

This application is related to the following U.S. patent applications, the contents of which are incorporated by reference herein:
U.S. patent application Ser. No. 11/562,514, entitled Location Toolbar For Internet Search and Communication, filed on Nov. 22, 2006.

### BACKGROUND OF THE INVENTION

1. Field of the Invention

This invention is generally related to location based services and, more specifically, to methods of and systems for a server to automatically retrieve a device's location from the device to optimize on-line communications such as information search.

2. Description Of Related Art

An increasing number of web sites are location aware, which provide a user experience tailored to the user's physical location. Retailers help users find their closest stores; Google Maps helps users find their way around; Fandango tells users which movies are playing close-by, and so on. All those current web sites require the user to manually enter his location and send it to the server.

Skyhook Wireless Loki

Launched in March 2006, Loki is a toolbar for Microsoft's Internet Explorer and Mozilla's Firefox browsers that maintains a list of location-aware web sites called channels. When the user requests a channel, Loki determines the user device's location by utilizing a WLAN positioning system (WPS), by using, for example, the techniques discussed in the applications incorporated below. The software then directs the browser to the web site by embedding the calculated location into the hard-coded URL or form for that particular channel.

Microsoft LocateMe

Launched in May 2005, LocateMe is a feature of the Virtual Earth product (now renamed Microsoft Live Local). LocateMe downloads a client application to a Windows XP machine that utilizes the 802.11 adapter to scan for nearby wireless signals. Those signals are then sent to the Virtual Earth server over the Internet. The Virtual Earth server contains a collection of “wardriving” data Microsoft licensed from community wardriving groups. If the user is within range of access points within that database, then LocateMe calculates the user location and plots that location on a Virtual Earth map.

### BRIEF SUMMARY OF THE INVENTION

The invention provides systems and methods of automatically retrieving location information from a user device for use with server systems.

Under one aspect of the invention, a method of a web server automatically retrieving from a mobile client device information indicative of a geographic position of the mobile client device for use in selecting information based on the geographic position and sending the selected information to the mobile client device includes providing the web server having location independent content and location dependent content. The mobile client device sends a first message to the web server requesting content. In response to the first message from the mobile client device, the web server sends a second message to the mobile client device requesting information indicative of the geographic position of the mobile client device. In response to the second message from the web server, the mobile client device automatically sends information indicative of the geographic position of the mobile client device to the web server. In response to receiving the information indicative of the geographic position of the mobile client device, the web server selects location dependent content that corresponds to the client geographic position and sends said location dependent content to the mobile client device.

Under another aspect of the invention, the information indicative of the geographic position of the mobile client device is provided by a WLAN positioning system that estimates the geographic position of the mobile client device based on signals sent by WLAN-enabled access points that are received by the mobile client device.

Under a further aspect of the invention, the information indicative of the geographic position of the mobile client device includes at least one of the group consisting of a city identifier, a street address, a postal code, and a latitude and longitude pair.

Under yet a further aspect of the invention, the mobile client device solicits permission from a user of the mobile client device to send the information indicative of the geographic position of the mobile client device to the web server.

Under yet another aspect of the invention, in response to the first message from the mobile client device, the web server provides to the mobile client device computer executable logic for determining the geographic position of the mobile client device. The computer executable logic receives the second message from the web server and the computer executable logic provides the information indicative of the geographic position of the mobile client device for sending to the web server.

Under another aspect of the invention, a method of a server system automatically retrieving from a mobile client device information indicative of a geographic position of the mobile client device for use in sending content based on the geographic position includes the server system receiving a registration message from the mobile client device informing the server system that the mobile client device is available for information exchange. Subsequent to the registration message from the mobile client device, the server system sends at least one query message to the mobile client device requesting information indicative of the geographic position of the mobile client device. In response to the at least one query message from the server system, the mobile client device automatically sends information indicative of the geographic position of the mobile client device to the server system. The server system sends content based on the information indicative of the geographic position to at least one of the mobile client device and another device.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 is an overview of a system for automatically retrieval of location information from a user device.

FIG. 2 is a flow chart illustrating an example of a server automatically retrieving the user's location information.

FIG. 3 is a flow chart illustrating a further example of a server automatically retrieving the user's location information.

FIG. 4 is a flow chart illustrating a client downloading an intelligent agent that requests the user's location on behalf of the server.

FIG. 5 is an overview of a server utilizing a WLAN Positioning System to determine the user's location of behalf of the user device.

FIG. 6 illustrates a user interface for prompting the user to allow or deny a request from a server to determine the user's location.

FIG. 7 illustrates a user interface for prompting the user to blur the location returned to the server.

FIG. 8 illustrates a user interface for enabling the user to manage permanent settings to allow or deny servers' requests to determine the user's location.

FIG. 9 is a flow chart illustrating a server automatically retrieving the user's location information independent of a request from the user.

### DETAILED DESCRIPTION OF THE INVENTION

Preferred embodiments of the invention provide new functionality to allow a web server to retrieve a user's current location at runtime. This differs from previous models where the client transmitted the user's location into existing HTML forms or URLs. The previous model requires the client to be aware of the server's interface, and requires the client to be tailored to handle each server on a case-by-case basis. Moreover, any change to the server's interface would require a change to every client using that server. By contrast, the new functionality of preferred embodiments of the invention allow servers to automatically retrieve the user's location from the client through a generic interface that can be used by all servers. Through various methods, the client determines its location, for example by utilizing a Global Positioning System (GPS) device or the techniques disclosed in the applications incorporated below, and makes the location information available to the server, which can then adapt its behavior based on the user's location.

An example of such an application is store-finder page on a retailer's web site. Today a store-finder page typically requires the user to manually enter and submit his location The user is subsequently presented with a list of the closest store locations. With the new functionality introduced by preferred embodiments of the present invention, the store-finder page could automatically determine the user's location by interrogating the web browser and can directly present the user the closest store locations.

The embodiments of the invention described herein may be used with the WLAN based location systems (i.e., the WPS) and methods described in U.S. patent application Ser. No. 11/261,988, entitled Location-Based Services that Choose Location Algorithms Based on Number of Detected Access Points Within Range of User Device, filed on Oct. 28, 2005, U.S. patent application Ser. No. 11/678,301, entitled Methods and Systems For Estimating a User Position In a WLAN Position System Based On User Assigned Access Point Locations, filed on Feb. 23, 2007, U.S. patent application Ser. No. 11/430,224, entitled Calculation of Quality of WLAN Access Point Characterization for Use In a WLAN Positioning System, filed on May 8, 2006, and U.S. patent application Ser. No. 11/430,222, entitled Estimation of Position Using WLAN Access Point Radio Propagation Characteristics In a WLAN Positioning System, filed on May 8, 2006, which are herein incorporated by reference and with the methods disclosed herein. Those applications taught specific ways to gather high quality location data for Wi-Fi access points so that such data may be used to estimate the geographic position, speed, and bearing of a Wi-Fi-enabled device utilizing such services and techniques of increasing the accuracy of the various estimations. The present techniques, however, are not limited to systems and methods disclosed in the incorporated patent applications. Thus, while reference to such systems and applications may be helpful, it is not believed necessary to understand the present embodiments or inventions.

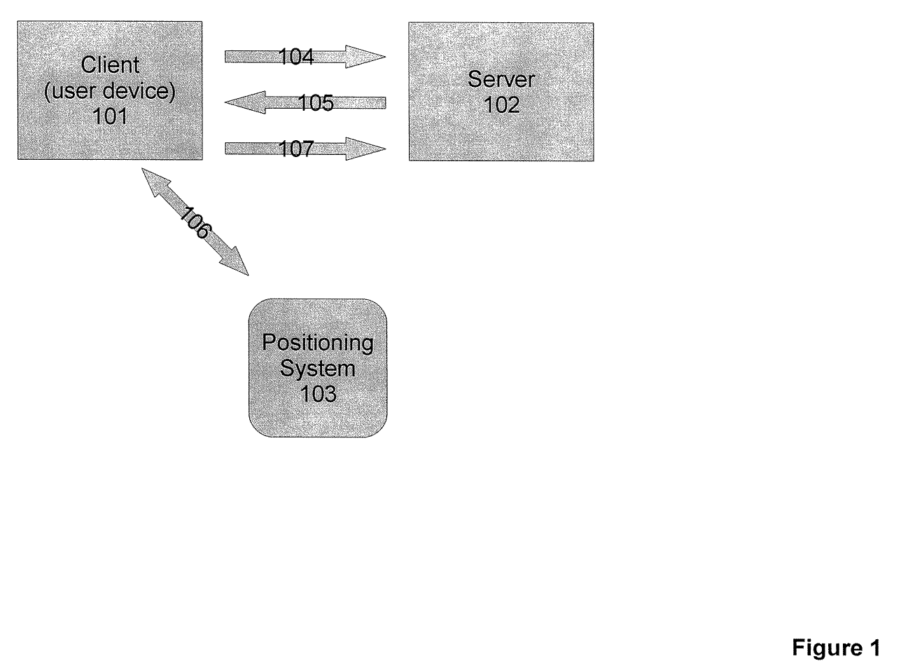

FIG. 1 is an overview of a system for automatically retrieval of location information from a user device. FIG. 1 depicts a portion of a preferred embodiment of the invention. In a typical client-server environment the client device [101] exchanges messages [104, 105 and 107] with a server [102]. In the course of the exchange between the client and the server, the server embeds in a message [105] a marker to indicate it requires the client's location. That request is interpreted by the client, which determines its location by utilizing a positioning system [106 and 103], for example the WLAN Positioning System (WPS). The client's location is embedded in a message to the server [107], which can decode it and tailor the messages it sends to the client. If the client isn't location-aware it could either returned a failure back to the server, e.g. “message not supported”, or the client can simply ignore the server's marker. It is recommend that the client report an error if it is location-aware but cannot determine a location instead of ignoring the server's request. In this way, the server can distinguish between a client that is not location-aware and a client that is location-aware but cannot determine its location at that time. Optionally, a client could indicate to the server it is location-aware by embedding a marker in the initial messages it sends to the server.

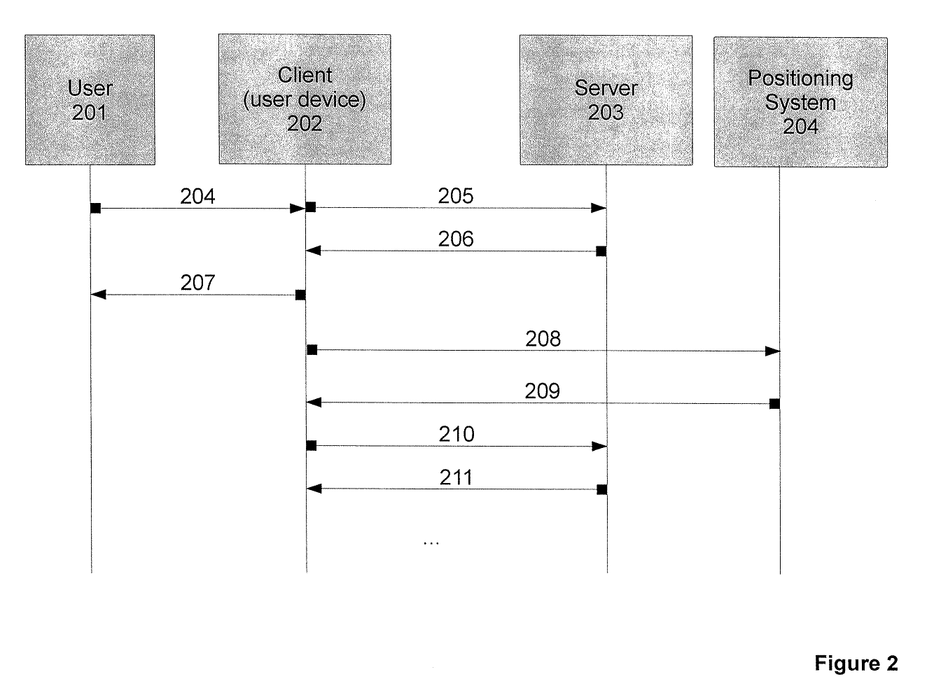

FIG. 2 is a flow chart illustrating an example of a server automatically retrieving the user's location information. FIG. 2 details a simple exchange between the client [202] and the server [203] where the user [201] directly initiates a request [204] to the web server, for example, by entering a URL into the address bar of a browser. This action results in the web server requesting the user's location. As part of the HTTP protocol, the client issues a request to the server [205]. The client can optionally indicate in the request [205] that the client is location enabled, although this is not necessary. The server embeds in a response [206] to the request [205] a marker indicating the server requires the device's location.

When the client detects the presence of the marker, it checks for the user's permission [207], as described in greater detail below, before determining its location by interrogating [208 and 209] a positioning system [204]. Assuming the user allows his location to be sent to the server, the client embeds its location in subsequent messages to the server [210]. Once the server receives the client's location, it may tailor its responses [211] based on that location. For example, a web page for a retail outlet can modify product offerings based on the products available at the stores nearest the user. Note that this customized response is triggered by the web server and not by the client.

One method for the web server to indicate it that it requires the device's location is to use HTTP “cookies”. Using this technique, the server adds a “Set-Cookie” header in its response to the client's request with a predefined cookie name. This follows the traditional method for setting cookies. A web browser enabled to detect such cookies would substitute the actual user's location as the value of the cookie. This use of cookies is unique. The server normally sets both the cookie's name and also it's value. Cookies are typically a mechanism for the server to store, on the client, some information for some period of time. In this case, the server only uses the cookie as a conduit for information known by the client. The server sets the cookie's name and a template describing the type of location requested, for example, latitude/longitude, street address, the location's name, the location's label (e.g., home, work, etc.). The template may also include other location attributes, such as the estimated error of the calculated location, speed, bearing, and/or altitude. The client substitutes the template set by the server with the actual cookie's value, namely, the location information requested by the server.

Once set, the cookie would be included in every subsequent HTTP requests as an HTTP header, just like a traditional cookie. The client may or may not recalculate the device's location for each HTTP request; a mobile web browser in a cell phone, for example, may recalculate the device's location for each HTTP request, whereas a browser in a laptop may not. The server can then retrieve the user's location by reading the cookie. If the web browser isn't location-aware it would leave the cookie unchanged, effectively communicating to the server it isn't location-aware. If the web browser is location-aware but cannot determine its location, or if the user is preventing it from reporting his location, the web browser would substitute the template with no value, effectively communicating to the server it is unable to determine its location.

Another method for a web server to indicate it requires the user device location is to use a specific HTTP header. A web browser enabled to handle such a header would substitute the actual user's location as the value of the header and include that header in subsequent HTTP messages with the server. This method is a more generic version of the cookie method described above, as cookies are transmitted via an HTTP header. In a similar way, the client can include an HTTP header to indicate it is location-aware.

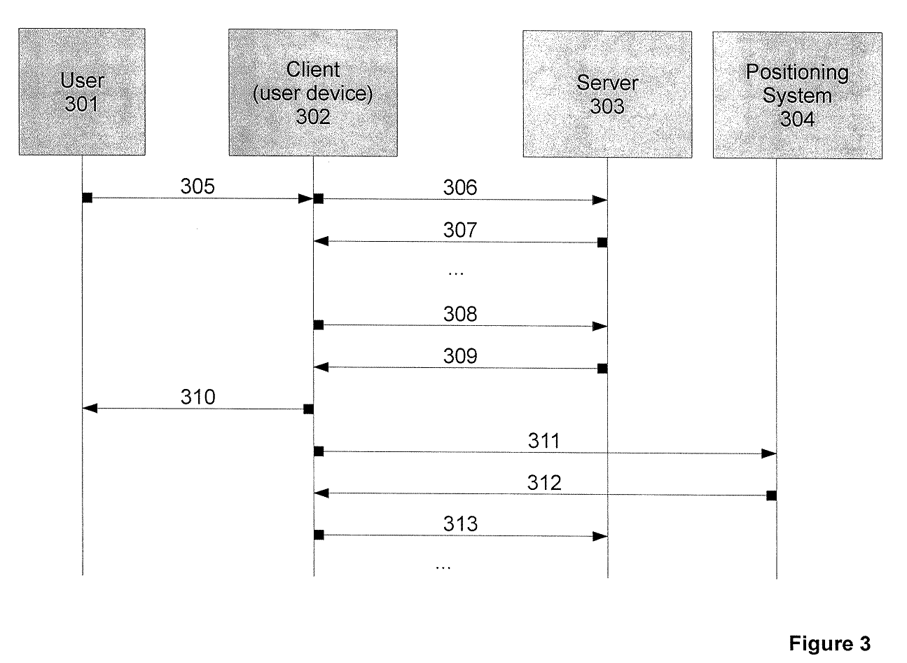

FIG. 3 is a flow chart illustrating a further example of a server automatically retrieving the user's location information. FIG. 3 depicts a more complex exchange between the client [302] and the server [303] where the server requests the user's location indirectly from the initial page requested [305] by the user [301]. For example, the request to the server that triggers the location request may be included in the main page as a frame. As part of the protocol, the client [302] issues a request for the main page [306]. The client can indicate in this message it is location enabled, although this is not necessary. Unlike the model depicted in FIG. 2, the server's response [307] does not include a marker indicating it requires the device's location. Instead, at a later time, as a result of requesting additional pages [308], the server sends a message [309] to the client indicating it requires the device's location. As the client interprets the message from the server, it checks for the user's permission [310], discussed below, before determining the client's location by interrogating [311 and 312] a positioning system [304]. Assuming the user has allowed his location to be sent to the server, the client embeds its location in subsequent messages to the server [313]. Once the server receives the client's location, the server may tailor its behavior based on the location, as discussed above.

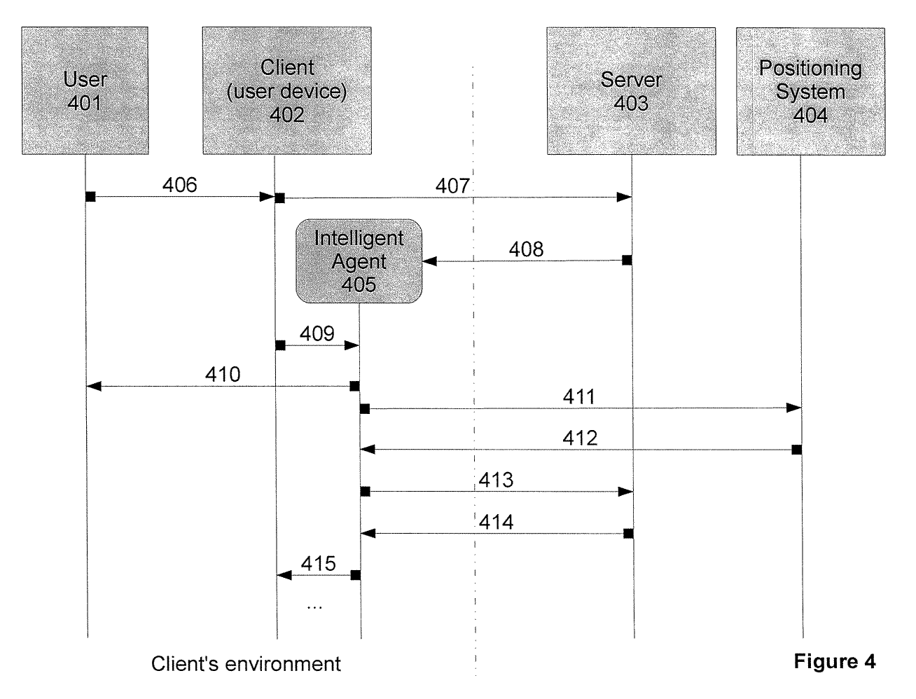

FIG. 4 is an illustration of a client [402] downloading an intelligent agent [405] from a server [403]. The intelligent agent [405] requests the user's location on behalf of the server and is a piece of code/logic to be executed in the client's context by the client on behalf of the server. The intelligent agent [405] determines the user's location. The user [401] visits a web page [406]. The web browser issues a request [407] for that main page to the server whose response [408] includes, either directly or indirectly, the intelligent agent. When executed by the client [409], the intelligent agent determines the user's location by interrogating [411 and 412] a positioning system [404]. The positioning system can be, for example, the WLAN Positioning System described in the applications incorporated above. As in the embodiments described above, the intelligent agent [405] confirms that the user has granted permission to release the location information [410] (described below). The intelligent agent [405] is then able to either communicate back with the server [413] to provide the client's location, or the agent can interact with the client [415] to alter the client's behavior based on the location the agent determined.

An example of a system employing an intelligent agent is a dynamic web site utilizing JavaScript as the intelligent agent. The client, a web browser with a JavaScript engine, downloads the JavaScript code from the server. The JavaScript code determines the browser's location and alters the web page presented to the user based on the location information using various techniques offered to client-side scripts, like DHTML. One method to interrogate a positioning system to determine the user's location from JavaScript is to extend the JavaScript engine. Two major web browsers today, Microsoft Internet Explorer and Mozilla Firefox, allow for extensions to be installed, via ActiveX for Internet Explorer and via XPCom for Firefox. Once installed, those extensions may be called as integral part of the JavaScript engine from scripts downloaded from any web site.

For example, the following JavaScript code is a very simplified example that displays an alert message once the JavaScript code has determined the user's location. It does so by calling an extension capable of determining the user's location via a WPS installed on the client exposing itself as “Loki” in JavaScript:

```
var loki = new Loki;
loki.requestLocation(function(status, location))
{
  if (status == 200)
    alert(“location: “+location.latitude+”, “+location.longitude);
}
```

Using similar techniques, the location information retrieved from the WPS, or other positioning system, can be passed back to the server, using, for example, the cookie or HTTP header methods discussed above.

Another example of such a system is a Java Web Start application or a Java applet. The client, a java-enabled computer platform, downloads the Java Web Start application or the Java applet and executes it. Unlike the JavaScript environment described above, Java already provides a mechanism for extending the core engine so that a positioning system can be interrogated without requiring a pre-installed extension. Yet another example of such a system is the Adobe FLEX development framework or Microsoft's SilverLight system.

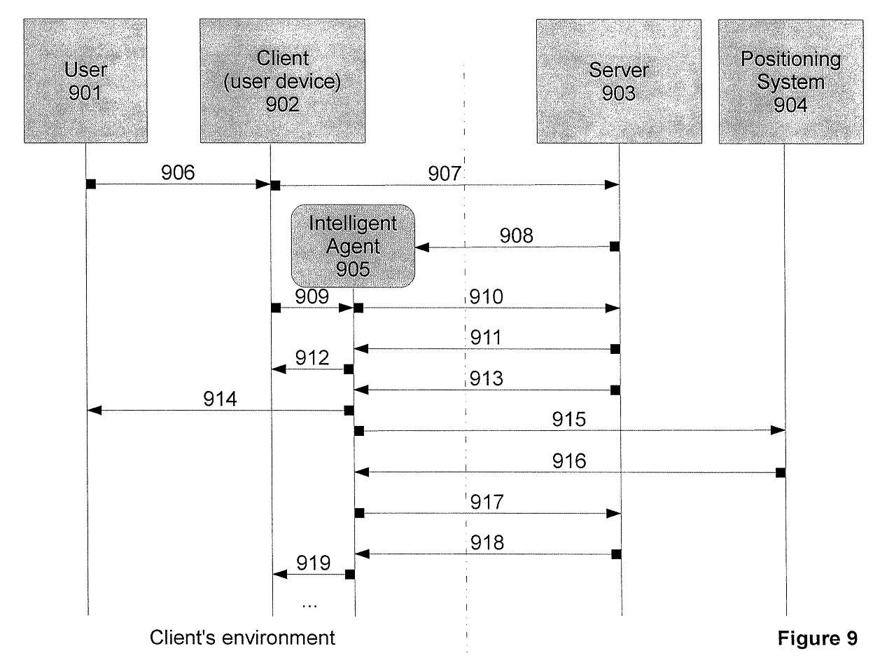

FIG. 9 is a flow chart illustrating a server automatically retrieving the user's location information independent of a request from the user. FIG. 9 depicts a client [902] downloading from the server [903] an intelligent agent [905]. As described above, the agent is a piece of code/logic to be executed in the client's context by the client on behalf of the server. It determines the user's location upon an asynchronous request from the server. The user [901] visits a web page [906] through the user device. The web browser issues a request [907] to the server [903] for a page. The server's response [908] includes, either directly or indirectly, the intelligent agent [905]. When executed by the client [909], the intelligent agent [905] registers with the server [910], and performs any other non-location related exchanges with the server that are needed.

As a result of this initial exchange, the intelligent agent may update [912] the client with information from the server [903]. At a later time, and asynchronously from a client's request, the server [903] can send a request [913] to the intelligent agent [905] for the user's location. Upon receipt of the server's request [913], the intelligent agent [905] determines the user's location by interrogating [915 and 916] a positioning system [904] (e.g., the WLAN Positioning System) after having checked permissions with the user [914] (described in greater detail below). The intelligent agent responds [917] to the servers' request for the user's location. This enables the server [903] to tailor its further interactions [918 and 919] with the client through the intelligent agent.

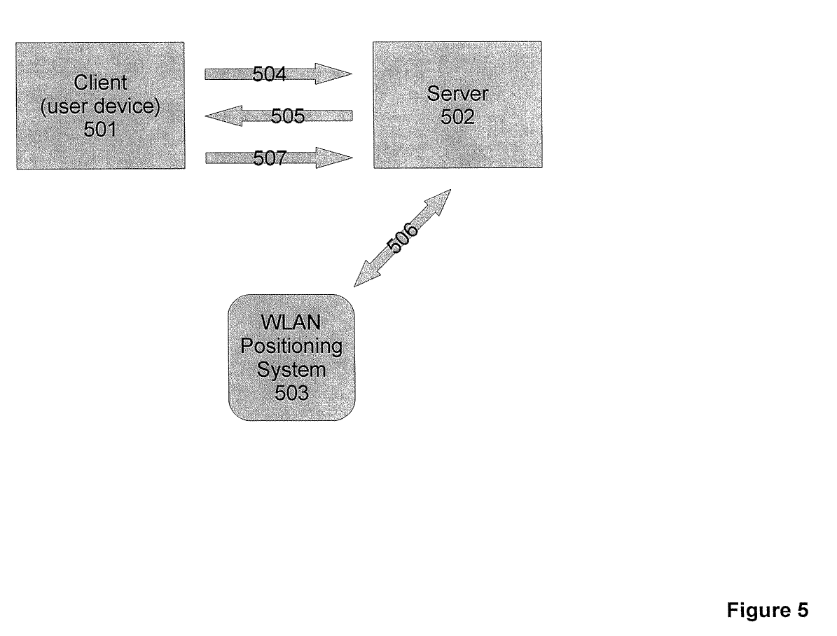

FIG. 5 is an overview of a server utilizing a WLAN Positioning System to determine the user's location of behalf of the user device. FIG. 5 depicts a server using a WLAN positioning system (WPS) [503] on behalf of the client to determine its location. Unlike previously described, the client [501] doesn't determine its location upon request from a server [502]. Instead, the client sends enough information [507] for the server [502] to determine the client's location by interrogating [506] the WPS system [503] on behalf of the client. For example, the client gathers Wi-Fi radio signal information from surrounding WLAN-enabled access points. The client then sends this information to the WPS [503], and the WPS [503] uses the techniques disclosed in the above-incorporated applications to determine the client's location. The mechanisms by which the client [501] sends the Wi-Fi radio signal information to the server can be the same as the mechanisms described above (i.e., using HTTP cookies or headers).

To preserve the user's privacy, the client can optionally inform the user that the server is requesting his location and give him the opportunity to allow or deny a request to such request. In addition, the client can allow the user to modify the location information sent to the server, for example, by only providing the zip code of the user's location instead of his complete street address. Further, the client can enable the user to blur his location within a certain range of his actual location or enable the user to employing “fuzzing” methods.

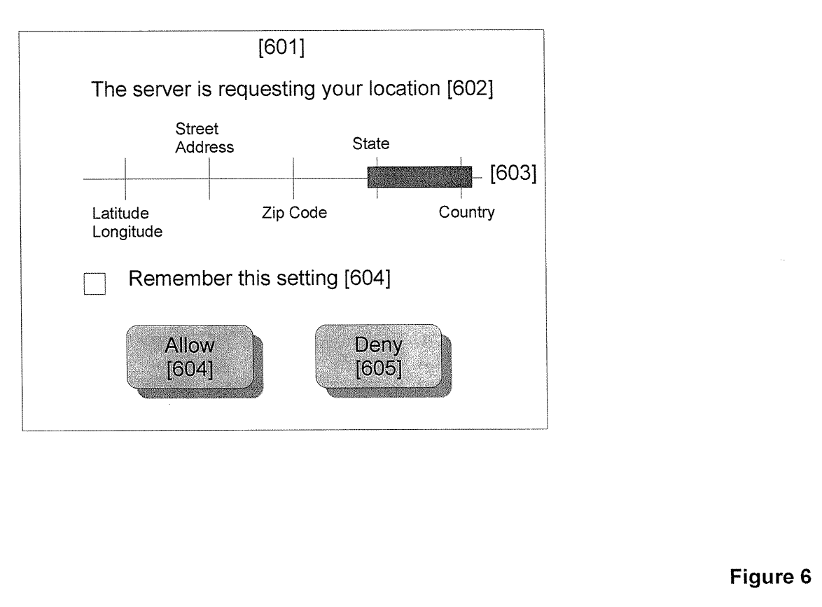

FIG. 6 illustrates a user interface for prompting the user to allow or deny a response to a request from a server to determine the user's location. FIG. 6 depicts an simplistic user interface for such a prompt using a window dialog [601]. The dialog would contain a message [602] explaining the reason for the prompt, a slider [603] to set the type of location information the user is willing to advertise, and buttons to allow [604] or deny [605] a response to the server's request to determine the client's location. A check box [604] can be provided to enable the user to have the system remember the setting and not prompt again, effectively making this setting permanent.

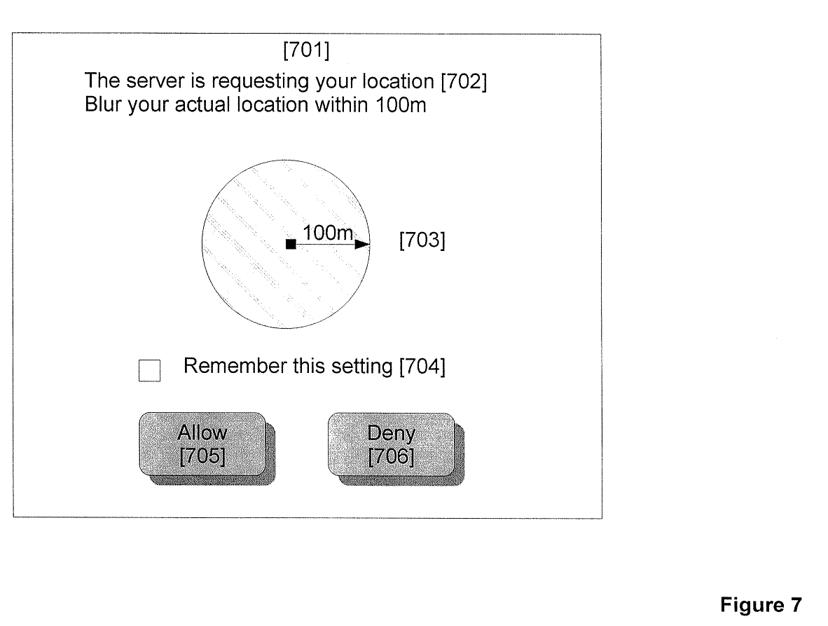

FIG. 7 illustrates a user interface for prompting the user to blur the location returned to the server. FIG. 7 depicts another simplistic user interface for a prompt [701] allowing the user to specify a range to blur his location, in which case the client would randomly return a location within the specified range from the actual physical location determined by the positioning system. The dialog box would contain a message [702] explaining the reason for the prompt and a visual representation of the blur radius [703], for example, a circle for easy visual feedback. A check box [704] can be provided to enable the user to have the system remember the setting and not prompt again. Finally, two buttons to allow [705] or deny [706] a response to the request are provided.

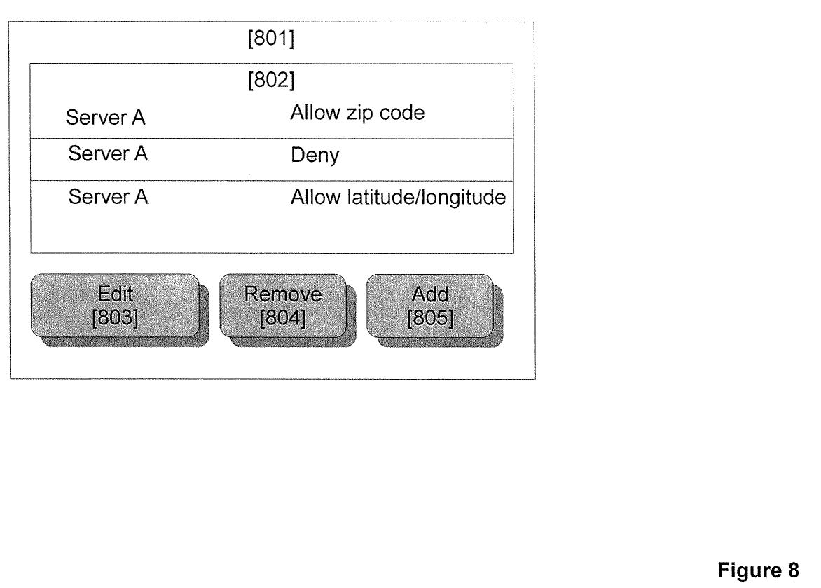

In addition to the prompts depicted in FIGS. 6 and 7, another prompt is provided to enable the user to manage the permanent permission settings. FIG. 8 illustrates a user interface [801] for enabling the user to manage permanent permission settings. The interface [801] shows the permanent settings [802], and enables the user to edit, remove and add permanent settings. By clicking on the Edit button [803], the user can fine tune the selected permanent settings to adjust the type of location information the user is willing to advertise to that server. By clicking on the Remove button [804], the user can remove the selected permanent setting, and would therefore be prompted again if that server requests the user's location at a future time. By clicking on the Add button [805], the user is able to manually enter a permanent setting before the server requests the user's location.

It will be appreciated that the scope of the present invention is not limited to the above-described embodiments, but rather is defined by the appended claims, and these claims will encompass modifications of and improvements to what has been described. For example, embodiments have been described as using a WLAN Positioning System or GPS system for position estimation. However, embodiments of the invention can be implemented using cell-tower triangulation, TV-tower triangulation or other position determination methods.

What is claimed is:

1. A method of a web server automatically retrieving from a mobile client device information indicative of a geographic position of the mobile client device for use in selecting information based on the geographic position and sending the selected information to the mobile client device, the method comprising:
providing the web server having location independent content and location dependent content;
the mobile client device sending a first message to the web server requesting content;
in response to the first message from the mobile client device, the web server sending a second message to the mobile client device requesting information indicative of the geographic position of the mobile client device;
in response to the second message from the web server, the mobile client device automatically sending information indicative of the geographic position of the mobile client device to the web server; and
in response to receiving the information indicative of the geographic position of the mobile client device, the web server selecting location dependent content that corresponds to the client geographic position and sending said location dependent content to the mobile client device.

2. The method of claim 1, wherein the information indicative of the geographic position of the mobile client device is provided by a WLAN positioning system that estimates the geographic position of the mobile client device based on signals sent by WLAN-enabled access points that are received by the mobile client device.

3. The method of claim 2, wherein the WLAN positioning system on the mobile client device communicates with a remote computer to estimate the geographic position of the mobile client device.

4. The method of claim 1, wherein the information indicative of the geographic position of the mobile client device is provided by a Global Positioning System.

5. The method of claim 1, further comprising the mobile client device estimating the geographic position of the mobile client device in response to receiving the second message from the web server.

6. The method of claim 1, wherein the information indicative of the geographic position of the mobile client device and the messages to and from the mobile client device are communicated using at least one of HTTP and HTTPS protocol.

7. The method of claim 6, wherein the request to the mobile client device for the information indicative of the geographic position of the mobile client device includes setting an HTTP cookie on the mobile client device, and wherein the mobile client device modifies the value of the HTTP cookie with information indicative of the geographic position of the mobile client device for sending to the web server.

8. The method of claim 1, wherein the information indicative of the geographic position of the mobile client device includes at least one of the group consisting of a city identifier, a street address, a postal code, and a latitude and longitude pair.

9. The method of claim 1, wherein the information indicative of the geographic position of the mobile client device includes a blurred position of the mobile client device generated by modifying an estimated position of the mobile client device by a random distance.

10. The method of claim 1, wherein the information indicative of the geographic position of the mobile client device is sent to the web server in a predetermined format, wherein the format is accepted by more than one web server.

11. The method of claim 1, further comprising the web server sending location independent content to the mobile client device.

12. The method of claim 1, further comprising:
the mobile client device soliciting permission from a user of the mobile client device to send the information indicative of the geographic position of the mobile client device to the web server.

13. The method of claim 12, wherein the soliciting permission from the user includes soliciting more than one permission, each permission having a corresponding type of geographic position information, each type having a different level of detail describing the geographic position.

14. The method of claim 12, wherein the soliciting permission from the user occurs before the mobile client device sends the first message to the web server such that the user pre-approves the mobile client device sending information indicative of the geographic position of the mobile client device to the web server.

15. The method of claim 1, wherein the first message includes an indication from the mobile client device that it can send information indicative of the geographic position of the mobile client device.

16. The method of claim 1, further comprising:
in response to the first message from the mobile client device, the web server providing to the mobile client device computer executable logic for determining the geographic position of the mobile client device;
wherein the computer executable logic receives the second message from the web server and the computer executable logic provides the information indicative of the geographic position of the mobile client device for sending to the web server.

17. The method of claim 16, wherein the computer executable logic includes DHTML logic.

18. The method of claim 17, wherein the computer executable logic includes JavaScript logic.

19. The method of claim 1, wherein the information indicative of the geographic position of the mobile client device consists essentially of information derived from signals transmitted by WLAN-enabled access points in range of the mobile client device.

20. A method of a server system automatically retrieving from a mobile client device information indicative of a geographic position of the mobile client device for use in sending content based on the geographic position, the method comprising:
the server system receiving a registration message from the mobile client device informing the server system that the mobile client device is available for information exchange;
subsequent to the registration message from the mobile client device, the server system sending at least one query message to the mobile client device requesting information indicative of the geographic position of the mobile client device;
in response to the at least one query message from the server system, the mobile client device automatically sending information indicative of the geographic position of the mobile client device to the server system; and
the server system sending content based on the information indicative of the geographic position to the mobile client device.

21. The method of claim 20, wherein the information indicative of the geographic position of the mobile client device is provided by a WLAN positioning system that estimates the geographic position of the mobile client device based on signals sent by WLAN-enabled access points that are received by the mobile client device.

22. The method of claim 21, wherein the WLAN positioning system on the mobile client device communicates with a remote computer to estimate the geographic position of the mobile client device.

23. The method of claim 20, wherein the information indicative of the geographic position of the mobile client device is provided by a Global Positioning System.

24. The method of claim 20, further comprising the mobile client device estimating the geographic position of the mobile client device in response to receiving the at least one query message from the server system.

25. The method of claim 20, wherein the information indicative of the geographic position of the mobile client device includes at least one of the group consisting of a city identifier, a street address, a postal code, and a latitude and longitude pair.

26. The method of claim 20, wherein the information indicative of the geographic position of the mobile client device includes a blurred position of the mobile client device generated by modifying an estimated position of the mobile client device by a random distance.

27. The method of claim 20, wherein the information indicative of the geographic position of the mobile client device is sent to the server system in a predetermined format, wherein the format is accepted by more than one server system.

28. The method of claim 20, further comprising:
the mobile client device soliciting permission from a user of the mobile client device to send the information indicative of the geographic position of the mobile client device to the server system.

29. The method of claim 28, wherein the soliciting permission from the user includes soliciting more than one permission, each permission having a corresponding type of geographic position information, each type having a different level of detail describing the geographic position.

30. The method of claim 28, wherein the soliciting permission from the user occurs before the server system sends the at least one query message to the mobile client device such that the user pre-approves the mobile client device sending information indicative of the geographic position of the mobile client device to the server system.

31. The method of claim 20, wherein the registration message includes an indication from the mobile client device that it can send information indicative of the geographic position of the mobile client device.
